(19) United States
(12) Patent Application Publication
(10) Pub. No.: US 2005/0058153 A1
(43) Pub. Date: Mar. 17, 2005

(54) Common signaling method

(76) Inventors: John Santhoff, Carlsbad, CA (US); Steve Moore, Escondido, CA (US); Douglas Cummings, Carlsbad, CA (US)

Correspondence Address: PULSE-LINK, INC., 1969 KELLOGG AVENUE, CARLSBAD, CA, 92008, US

(21) Appl. No.: 10/835,441

(22) Filed: Apr. 28, 2004

Related U.S. Application Data
(63) Continuation-in-part of application No. 10/663,174, filed on Sep. 15, 2003.

(51) Int. Cl. H04L 12/28

(52) U.S. Cl. 370/466; 370/310

(57) ABSTRACT

A common signaling method is provided. The present invention provides compatibility and interoperability between different communication devices. In one embodiment, a medium access control is provided that enables communication between a first communication device having a first type of physical layer, and a second communication device having a second type of physical layer. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

This application is a continuation-in-part of co-pending U.S. non-provisional application Ser. No. 10/663,174 filed Sep. 15, 2003, entitled “ULTRA-WIDEBAND COMMUNICATION PROTOCOL.”

### FIELD OF THE INVENTION

The present invention relates to the field of wireless communications. More particularly the present invention describes a common communication method for communication devices.

### BACKGROUND OF THE INVENTION

The Information Age is upon us. Access to vast quantities of information through a variety of different communication systems are changing the way people work, entertain themselves, and communicate with each other. Faster, more capable communication technologies are constantly being developed. For the manufacturers and designers of these new technologies, achieving “interoperability” is becoming an increasingly difficult challenge.

Interoperability is the ability for one device to communicate with another device, or to communicate with another network, through which other communication devices may be contacted. However, with the explosion of different communication protocols (i.e., the rules communications equipment use to transfer data), designing true interoperability is not a trivial pursuit.

For example, most wireless communication devices employ conventional “carrier wave,” or radio frequency (RF) technology, while other devices use electro-optical technology. Generally, each one of these communication technologies employ their own communication protocol.

Another type of communication technology is ultra-wideband (UWB). UWB technology is fundamentally different from conventional forms of RF technology. UWB employs a “carrier free” architecture, which does not require the use of high frequency carrier generation hardware; carrier modulation hardware; frequency and phase discrimination hardware or other devices employed in conventional frequency domain communication systems.

Within UWB communications, several different types of networks, each with their own communication protocols are envisioned. For example, there are Local Area Networks (LANs), Personal Area Networks (PANs), Wireless Personal Area Networks (WPANs), sensor networks and others. Each network may have its own communication protocol.

Therefore, there exists a need for a common communication method for communication devices, which will allow for compatibility and coexistence between different networks, and different types of communication devices.

### SUMMARY OF THE INVENTION

The present invention provides a common communication method, or protocol for communications between different devices. Various embodiments of the invention provide features and functions that enable communication between disparate communication devices.

In one embodiment, a medium access control is provided that enables communication between a first communication device having a first type of physical layer, and a second communication device having a second type of physical layer.

In another embodiment, signaling information is communicated at a radio frequency. A medium access control is provided that enables a first communication device having a first type of physical layer, and a second communication device having a second type of physical layer to both receive the signaling information.

These and other features and advantages of the present invention will be appreciated from review of the following detailed description of the invention, along with the accompanying figures in which like reference numerals refer to like parts throughout.

### BRIEF DESCRIPTION OF THE DRAWING

FIG. 1 is an illustration of different communication methods;

FIG. 2 is an illustration of two ultra-wideband pulses;

FIG. 3 illustrates embodiments of combination frames, high data rate frames, and low data rate frames, all constructed according to the present invention; and

FIG. 4 illustrates a wireless network of transceivers constructed according to the present invention.

FIG. 5 illustrates a portion of the radio frequency spectrum;

FIG. 6 illustrates two communication devices constructed according to two embodiments of the present invention;

FIG. 7 illustrates a portion of the radio frequency spectrum and a plurality of radio frequency bands located thereon;

FIG. 8 illustrates three different communication methods;

FIG. 9 illustrates a network of communication devices constructed according to one embodiment of the present invention;

FIG. 10 illustrates two different types of communication methods overlaid upon one another; and

FIG. 11 illustrates a portion of a communication frame constructed according to one embodiment of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a common communication method, or protocol for communication between devices that employ different physical layers (“PHYs”). Various embodiments of the invention provide features and functions that enable communication between these different communication devices. In one embodiment, the present invention provides compatibility and interoperability between ultra-wideband communication devices and conventional, narrowband communication devices, each of which may use different PHYs. As defined herein, the “physical layer” provides the ability and procedures to activate and use physical components for bit transmission and reception. Thus, in wireless communications, the major function performed by the PHY are establishment and termination of a connection to a communication medium, such as the air, and conversion between the representation of digital data and the corresponding signals, or pulses, transmitted and/or received over the communication medium. Put simply, one function of the PHY is to change bits into pulses or into a modulated carrier wave. The PHY may be in the form of computer software, hardware or both software and hardware.

Generally, access to the PHY is controlled by a Medium Access Control layer (MAC). MACs are most often employed in Local Area Networks (LANs), but may be employed in other types of networks, including ad-hoc networks. The MAC is generally used to keep devices sharing a common communications channel from interfering with each other. The MAC may be in the form of computer software, hardware or both software and hardware.

Compatibility between similar communication devices becomes important as the devices achieve penetration into the marketplace. For example, a variety of conventional wireless devices use the unlicensed 2.4 GHz frequency for communications. WiFi, Bluetooth and cordless phones, to name a few. However, because no common communication standard was established, many of these devices cannot communicate with each other, and moreover, many of these devices interfere with each other.

One feature of the present invention is that it enables communication between different types of interfaces employed by different devices.

A preferred embodiment of the present invention provides a protocol designed to facilitate coexistence between multiple devices utilizing different ultra-wideband physical-layer air interfaces.

The Institute of Electrical and Electronics Engineers (IEEE) is currently establishing rules and communication standards for a variety of different networks, and other communication environments that may employ ultra-wideband technology. These different communication standards may result in different rules, or physical-layer air interfaces for each standard. For example, IEEE 802.15.3(a) relates to a standard for ultra-wideband Wireless Personal Area Networks (WPANs). Ultra-wideband may also be employed in IEEE 802.15.4 (a standard for sensors and control devices), 802.11n (a standard for Local Area Networks), ground penetrating radar, through-wall imaging, and other networks and environments. Each one of these devices may employ ultra-wideband communication technology, and each device may also have its own communication standard.

As ultra-wideband technology achieves widespread penetration into the marketplace, compatibility between ultra-wideband enabled devices will become important. One feature of the present invention is that it insures reliable communications between ultra-wideband devices sharing dissimilar physical-layer air interfaces.

Another feature of the present invention is that it may be employed in any type of network, be it wireless, wired, or a mix of wire media and wireless components. That is, a network may use both wire media, such as coaxial cable, and wireless devices, such as satellites, or cellular antennas. As defined herein, a network is a group of points or nodes connected by communication paths. The communication paths may be connected by wires, or they may be wirelessly connected. A network as defined herein can interconnect with other networks and contain subnetworks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology in use on it, for example, a TCP/IP network, and a Systems Network Architecture network, among others. A network as defined herein can also be characterized by whether it carries voice, data, or both kinds of signals or data. A network as defined herein can also be characterized by who can use the network, for example, a public switched telephone network (PSTN), other types of public networks, and a private network (such as within a single room or home), among others. A network as defined herein can also be characterized by the usual nature of its connections, for example, a dial-up network, a switched network, a dedicated network, and a nonswitched network, among others. A network as defined herein can also be characterized by the types of physical links that it employs, for example, optical fiber, coaxial cable, a mix of both, unshielded twisted pair, and shielded twisted pair, among others. The present invention may also be employed in any type of wireless network, such as a wireless PAN, LAN, MAN, WAN or WPAN.

The present invention is directed toward ultra-wideband technology, which in one embodiment is a “carrier free” architecture, which does not require the use of high frequency carrier generation hardware, carrier modulation hardware, stabilizers, frequency and phase discrimination hardware or other devices employed in conventional frequency domain communication systems. Conventional radio frequency technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

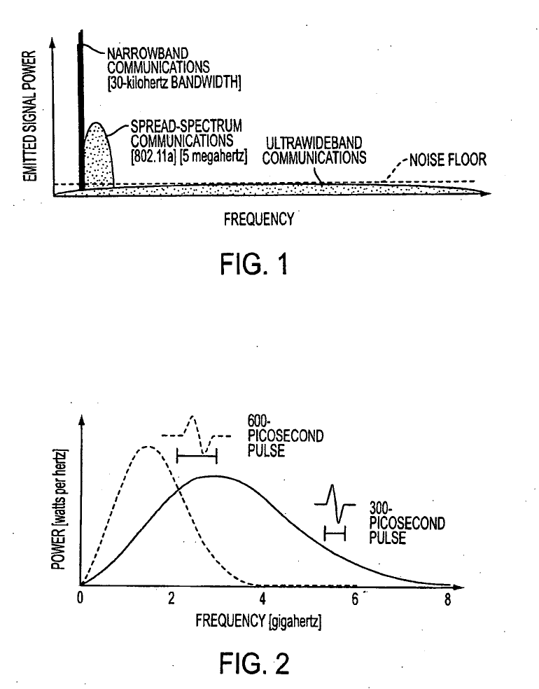

Referring to FIG. 1, another example of a conventional radio frequency technology is illustrated. 802.11a, a wireless local area network (LAN) protocol, transmits continuous sinusoidal radio frequency signals at a 5 GHz center frequency, with a radio frequency spread of about 5 MHz.

In contrast, ultra-wideband (UWB) communication technology employs discrete pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses are transmitted without modulation onto a sine wave carrier frequency, in contrast with conventional radio frequency technology as described above. A UWB pulse is a single electromagnetic burst of energy. A UWB pulse can be either a single positive burst of electromagnetic energy, or a single negative burst of electromagnetic energy, or a single burst of electromagnetic energy with a predefined phase. Alternate implementations of UWB can be achieved by mixing discrete pulses with a carrier wave that controls a center frequency of a resulting UWB signal. Ultra-wideband generally requires neither an assigned frequency nor a power amplifier.

In contrast to the relatively narrow frequency spread of conventional communication technologies, a UWB pulse may have a 2.0 GHz center frequency, with a frequency spread of approximately 4 GHz, as shown in FIG. 2, which illustrates two typical UWB pulses. FIG. 2 illustrates that the narrower the UWB pulse in time, the broader the spread of its frequency spectrum. This is because bandwidth is inversely proportional to the time duration of the pulse. A 600-picosecond UWB pulse can have about a 1.6 GHz center frequency, with a frequency spread of approximately 1.6 GHz. And a 300-picosecond UWB pulse can have about a 3 GHz center frequency, with a frequency spread of approximately 3.2 GHz. Thus, UWB pulses generally do not operate within a specific frequency, as shown in FIG. 1. And because UWB pulses are spread across an extremely wide frequency range or bandwidth, UWB communication systems allow communications at very high data rates, such as 100 megabits per second or greater. A UWB pulse constructed according to the present invention may have a duration that may range between about 10 picoseconds to about 100 nanoseconds.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by this reference.

Also, because the UWB pulse is spread across an extremely wide frequency range, the power sampled at a single, or specific frequency is very low. For example, a UWB one-watt pulse of one nano-second duration spreads the one-watt over the entire frequency occupied by the UWB pulse. At any single frequency, such as at the carrier frequency of a CATV provider, the UWB pulse power present is one nano-watt (for a frequency band of 1 GHz). This is calculated by dividing the power of the pulse (1 watt) by the frequency band (1 billion Hertz). This is well within the noise floor of any communications system and therefore does not interfere with the demodulation and recovery of the original signals. Generally, the multiplicity of UWB pulses are transmitted at relatively low power (when sampled at a single, or specific frequency), for example, at less than −30 power decibels to −60 power decibels, which minimizes interference with conventional radio frequencies. However, UWB pulses transmitted through most wire media will not interfere with wireless radio frequency transmissions. Therefore, the power (sampled at a single frequency) of UWB pulses transmitted though wire media may range from about +30 dBm to about −140 dBm.

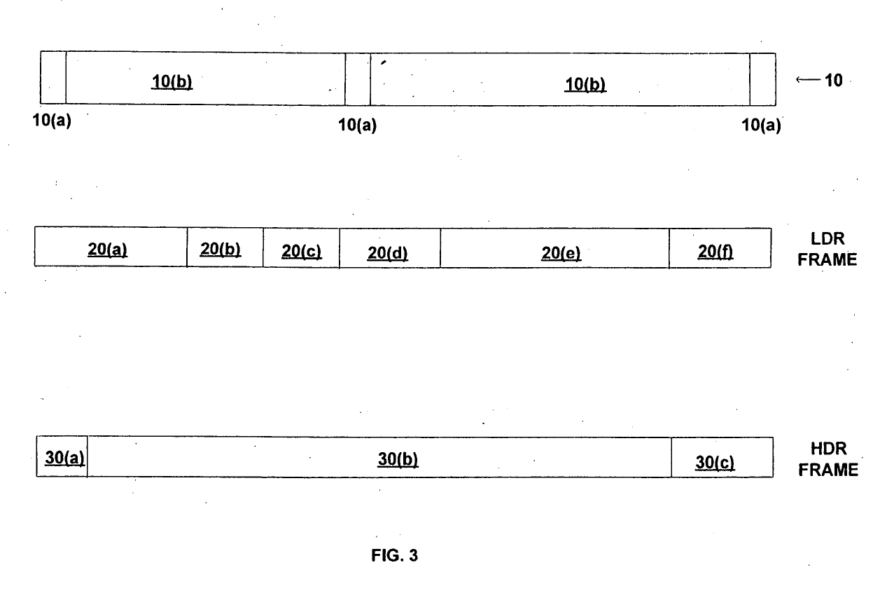

Referring now to FIG. 3, combination, or interleaved frames 10 constructed according to one embodiment of the present invention are illustrated. A “frame” as defined herein may include several different embodiments. Generally, a frame is data that is transmitted between communication points (i.e., mobile or fixed communication devices) as a unit complete with addressing and other protocol information. That is, a frame is configured by a set of rules and carries data between communication devices. In one embodiment, a frame includes data to be transmitted, error-correcting information for the data, an address, timing or synchronization information, and other features and functions depending on the protocol that the frame was formed under. A frame may include another frame within it, that may be configured, and/or used by a different protocol. A frame may also be configured similar to a Time Division Multiple Access (TDMA) frame.

As shown in FIG. 3, the combination frames 10 include both low data rate (LDR) frames 10(a) and high data rate (HDR) frames 10(b). Each LDR frame 10(a) may be configured to transmit data at a rate that may range between about 1 kilobit per second to about 5 megabits per second. Each HDR frame 10(b) may be configured to transmit data at a rate that may range between about 5 megabits per second to about 1 gigabit per second.

One feature of the present invention is that low data rate ultra-wideband (UWB) devices and high data rate UWB devices may communicate with each other through the use of combination frames 10. For example, one type of UWB device may use a protocol that is only capable of communication at relatively low data rates, while another UWB device may use a protocol that is capable of communication at relatively high data rates.

A UWB communication device employing the combination frames 10 protocol of the present invention would be able to communicate with both low and high data rate UWB devices. For example, a number of different applications of UWB technology have been proposed, with each having its own data rate capability. In a UWB PAN, the data rates may approach 480 Mbps and distances may be limited to 10 meters. In a LAN application the data rate may be variable dependent on the distance from the network access point. For example, if a UWB communication device is 10-meters from the access point, the data rate may be 500 Mbps. A user farther from the access point may have a 200 Mbps data rate. At a 100-meter distance from the access point the data rate may be only a few megabits per second. Another proposed application for UWB communications technology is a low data rate control and sensor data system. The low data rate application may be good for communicating geographic location information, and other low data rate information. A UWB device employing a communication protocol using combination frames 10 would be able to communicate with any or the above-described UWB networks and devices.

A UWB device constructed according to the present invention may employ both a low and a high data rate transceiver. A UWB device may be a phone, a personal digital assistant, a portable computer, a laptop computer, a desktop computer, a mainframe computer, video monitors, computer monitors, or any other device employing UWB technology.

Low data rate transceivers generally use small amounts of energy, with high data rate transceivers generally using significantly more energy. One advantage of the present invention is that a UWB communication device employing both a low and high data rate transceiver may use the low data rate (LDR) portion for discovery, control, network log on, and protocol negotiation while the high data rate (HDR) portion is powered down, thus conserving power and extending battery life. For example, the LDR transceiver may signal a local UWB device or network, and discover its communication capabilities. The LDR transceiver may then synchronize with the local UWB device/network and provide the synchronization information to the HDR transceiver, which until now, has been in sleep mode, thereby conserving energy. This type of communication sequence would employ a communication protocol that would use the combination frames 10 discussed herein.

As shown in FIG. 3, the combination, or interleaved sequence in combination frames 10 shows Low Data Rate (LDR) frames 10(a) interleaved with high data rate (HDR) frames 10(b). The frequency of occurrence of LDR frames 10(a) may vary with application and may be additionally dependent on the bandwidth demand of the device with which communication is desired. For example, the number of LDR frames 10(a) may increase when communicating with a low data rate device, and decrease when communicating with a high data rate device.

Both LDR frames 10(a) and HDR frames 10(b) are comprised of groups of symbol slots (not shown). The number of symbol slots in a frame may vary from about 100 to about 100,000. In one embodiment, each symbol slot is comprised of 25 time bins (not shown), with each time bin sized at about 400 picoseconds. Other time bin arrangements, with different time bin sizes, may also be constructed. Within one or more of these time bins, an ultra-wideband (UWB) pulse may be positioned, depending on the data modulation technique that is employed. That is, the position, amplitude, phase or other aspect of the UWB pulse(s) within one, or more of the time bins comprising a symbol slot represents one or more binary digits, or bits, that comprise the data that is being transmitted or received. A group of these symbol slots comprise a LDR frame 10(a) or HDR frame 10(b), thereby enabling the transmission and reception of data.

In one embodiment of the present invention, LDR frames 10(a) and/or HDR frames 10(b) may have a duration that may range between about one (1) microsecond to about one (1) millisecond.

For example, in one embodiment, the LDR frames 10(a) may be arranged as follows: As shown in FIG. 3, the LDR frame comprises many symbol slots (as discussed above) that may be allocated into groups that provide different communication functions. Positioned within each symbol slot are groups of time bins that have one or more UWB pulses located therein. The LDR frame may include an extended preamble and synchronization time 20(a). The preamble and synchronization time 20(a) may be extended to ensure sufficient time for a UWB transceiver to achieve a synchronization lock. The LDR frame may additionally include a control section 20(b) to pass control messages and responses to and from a UWB device. These control messages may include power on, power off, and frame number assignments for communications. Time period 20(c) may be utilized by the transceiver to send geographic location information to a remote UWB device. A contention-based bandwidth request 20(d) may be provided to allow UWB devices to request bandwidth from a network. That is, a number of contention-based methods such as ALOHA, slotted ALOHA, and sensing algorithms with and without collision detection may be used to request time in the network for data transmission. The data payload time period 20(e) of the LDR frame is used to pass low-data-rate data to and from a device/network. Data error detection and correction is provided in time period 20(f). It will be appreciated that the construction of LDR frame may be varied to suit different protocols, and communication needs.

Again referring to FIG. 3, the HDR frame may comprise a smaller preamble and synchronization time period 30(a), a significantly longer data payload time 30(b), and an error detection and correction period 30(c). Additionally, HDR frames may be transmitted at a different power level than LDR frames. The length, or time duration of LDR frames and HDR frames may vary with the environment in which the communication system is installed. In situations where there is more probability of losing synchronization in mid-frame, the length, or time duration of the frames may be reduced.

For example, to increase the quality and reliability of communication, each frame 10(a) or 10(b) may have an amount of “guard time,” which comprises time bins that are intentionally left empty. These empty time bins help the UWB device to locate the portion of the frame that contains UWB pulses. Depending on the communication modulation technique employed and/or the communications environment, the amount of guard time may be adjusted to accommodate multipath interference. In one embodiment, the number of LDR frames 10(a) may be significantly lower than HDR frames 10(b) (in a high data rate network), and less guard time may be required in the LDR frames 10(a). It will be appreciated that frames and time bins may have other durations, and that frames may employ different numbers of time bins.

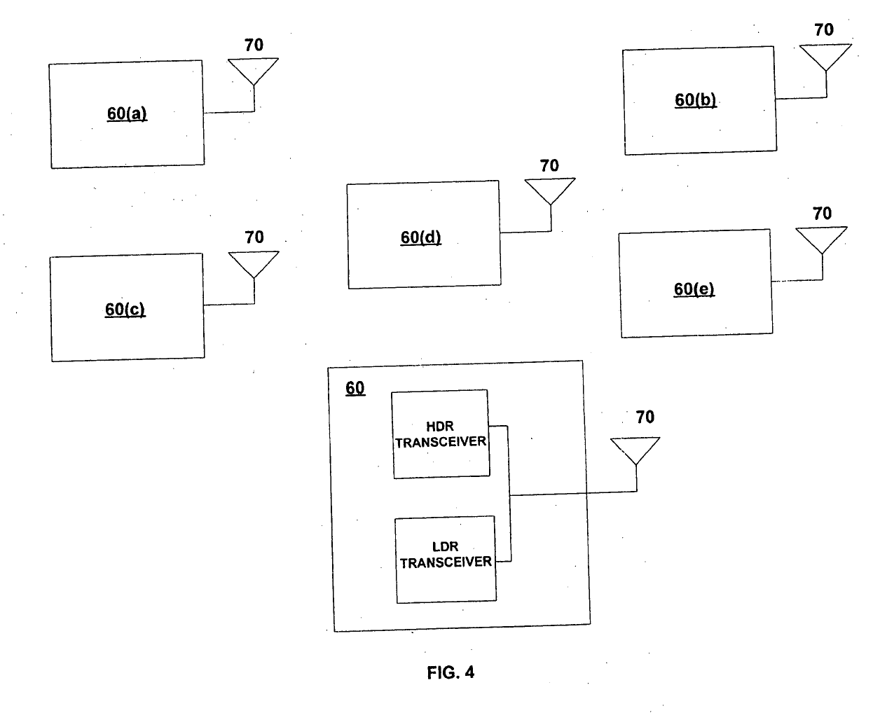

Referring now to FIG. 4, which illustrates one or more network(s) of UWB devices 60(a)-60(e). A UWB high-low data rate communication device 60 constructed according the present invention contains both a high data rate (HDR) transceiver and an low data rate (LDR) transceiver. All of the devices 60 and 60(a)-(e) include communication antennas 70. The high-low data rate communication device 60 includes communication protocol computer logic in either a hardware and/or software form that constructs combination frames 10 as discussed above. Thus, the high-low data rate communication device 60 may communicate with device 60(a) that is simply a UWB sensor (or ground penetrating radar, through-wall imager, precision locator, etc.), and can only communicate using low data rates. Or, high-low data rate communication device 60 may communicate with device 60(d), that is a mainframe computer which acts as a master transceiver that manages communications on a high data rate ultra-wideband network.

Thus, one feature of the present invention is that by providing a common signaling protocol that may communicate with all UWB communication devices, a UWB device employing one type of protocol with a low data rate may communicate with a network access point employing a different protocol using a high data rate.

Another feature of the present invention is that in an environment with multiple network access points, the high-low data rate communication device 60 may communicate with all available access points and log onto the most suitable network. For example, a high data rate mobile device whose transmitted signal occupies the entire available bandwidth may communicate when presented with a low data rate network access point.

Or, the high-low data rate communication device 60 may substantially simultaneously contact: a network access point that employs Orthogonal Frequency Division Multiplexing (OFDM); an access point whose high data rate signal occupies the entire available bandwidth; and a low data rate sensor, and the device 60 may contact each one across a low data rate channel using the common signaling protocol of the present invention. The device 60 and the access points may then do discovery across the low data rate channel. The low data rate access point and the OFDM style high data rate access point may offer connection across only the low data rate channel, to accommodate the low data rate sensor. The high data rate access point may offer either a high or a low data rate channel to the high-low data rate communication device 60. In this example, the high-low data rate communication device 60 may select to log onto the high data rate network.

Another feature of the present invention is that the LDR transceiver may send a power-on or wake-up signal to the HDR transceiver, both located within the high-low data rate communication device 60. In this embodiment, the LDR transceiver may additionally provide a coarse timing reference to the HDR transceiver, thus assisting with time synchronization.

Within a network, an initialization protocol for a fixed access point in the network may involve a listening time period prior to beacon initialization. In one feature of the present invention, if a beacon from a first access point is detected, a second access point may synchronize to the beacon signal emitted by the first access point. It is possible that these access points may be connected by a wire medium, such as fiber-optic cable, coaxial cable, twisted-pair wire, or other wire media. In this type of environment, the synchronization and initialization of an additional access point may be accomplished via the wire medium.

Again referring to FIG. 4, in another embodiment of the present invention, a fixed network access point, or master transceiver, such as 60(d) may periodically transmit a beacon signal at a low data rate. This beacon signal may include the geographic location of the master transceiver 60(d). A mobile high-low data rate communication device 60 that moves within the coverage area of the master transceiver 60(d) receives the beacon signal with the LDR transceiver and may use the geographic location information to assist in calculating its geographic location. Since the beacon signal may be primarily used for discovery, and logon, the signal modulation technique used for the beacon signal may alternate between techniques used by various transceivers. For example, the beacon signal may alternate between an on-off keying (OOK) signal that occupies a significant portion of the available bandwidth and an OFDM style signal. In this manner a transceiver expecting an OFDM style signal will be able to receive the low data rate frames and complete discovery using those beacon signals, while another type of transceiver may use the OOK beacon signal. Alternatively, a modulation method called binary phase shift keying (BPSK) may be employed by the present invention.

As mentioned above, there are several different types of signal modulation techniques and methods. Ultra-wideband pulse modulation techniques enable a single representative data symbol to represent a plurality of binary digits, or bits. This has the obvious advantage of increasing the data rate in a communications system. A few examples of modulation include: Pulse Width Modulation (PWM); Pulse Amplitude Modulation (PAM); and Pulse Position Modulation (PPM). In PWM, a series of predefined UWB pulse-widths are used to represent different sets of bits. For example, in a system employing 8 different UWB pulse widths, each symbol could represent one of 8 combinations. This symbol would carry 3 bits of information. In PAM, predefined UWB pulse amplitudes are used to represent different sets of bits. A system employing PAM16 would have 16 predefined UWB pulse amplitudes. This system would be able to carry 4 bits of information per symbol. In a PPM system, predefined positions within an UWB pulse timeslot are used to carry a set of bits. A system employing PPM16 would be capable of carrying 4 bits of information per symbol. All of the above-described signal modulation methods, as well as others (such as ternary modulation, 1-pulse modulation and others) may be employed by the present invention.

Another feature of the present invention is that the LDR frames (shown in FIG. 3) may provide a variety of functionalities, such as remote shut-down or wake-up of a selected UWB device, and wireless update of firmware of the selected UWB device. Updating the firmware of the UWB device allows for the device to avoid early obsolescence in a rapidly changing technology environment.

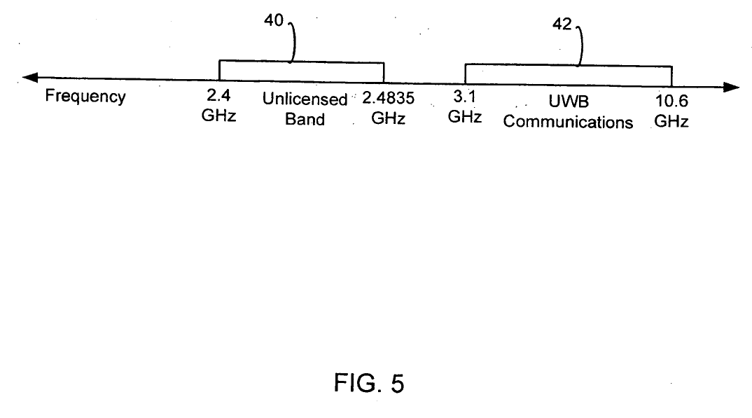

Referring now to FIGS. 5-11, additional embodiments and features of the present invention are illustrated. FIG. 5 illustrates a portion of the radio frequency spectrum, showing the frequency band of 3.1 GHz to 10.6 GHz, where ultra-wideband communication is allowed, and 2.4 GHz to 2.4835 GHz where 802.11, its derivatives such as Bluetooth and others, and other devices are permitted to operate.

One feature of the present invention, as embodied in the ultra-wideband (UWB) high-low data rate device 60, or any one of the UWB devices 60a-e, shown in FIG. 4, is that communication using low data rate (LDR) frames 10(a) may be at one radio frequency, and communication using high data rate (HDR) frames 10(b) may be at another radio frequency. That is, information transmitted using LDR frames 10(a) may be transmitted at a different radio frequency than information transmitted using HDR frames 10(b).

For example, referring to FIG. 5, which illustrates a lower frequency band 40 and a higher frequency band 42. In this illustration, the lower frequency band 40 comprises the unlicensed radio frequencies that extend from 2.4 GHz to 2.4835 GHz, and the higher frequency band 42 comprises 3.1 GHz to 10.6 GHz, which allows ultra-wideband communications. In this embodiment, LDR frames 10(a) may be transmitted as a Bluetooth-like signal. Alternatively, LDR frames 10(a) may be transmitted using a conventional carrier wave transmitted at other radio frequencies that are not shown in FIG. 5. Or, LDR frames 10(a) may be transmitted using ultra-wideband pulses that only use a portion of the 3.1 GHz to 10.6 GHz frequency band. HDR frames 10(b) may be transmitted using ultra-wideband pulses that use a different portion of the 3.1 GHz to 10.6 GHz frequency band. It will be appreciated that the exact radio frequencies employed by the LDR frames 10(a) and the HDR frames 10(b) may be other than those illustrated.

One feature of this embodiment is that the HDR transceiver in UWB high-low data rate device 60 does not have to cease transmission to allow the LDR frames 10(a) to be transmitted by the LDR transceiver. Since there is frequency separation between the LDR frames 10(a) and the HDR frames 10(b), the two signals, or pulse groups will not interfere with each other. Another feature of this embodiment is that by transmitting the LDR frames 10(a) on a conventional carrier wave, the carrier may be used to assist any of the UWB devices 60a-e in synchronization by providing a continuous signal for the UWB devices 60a-e to determine their timing reference.

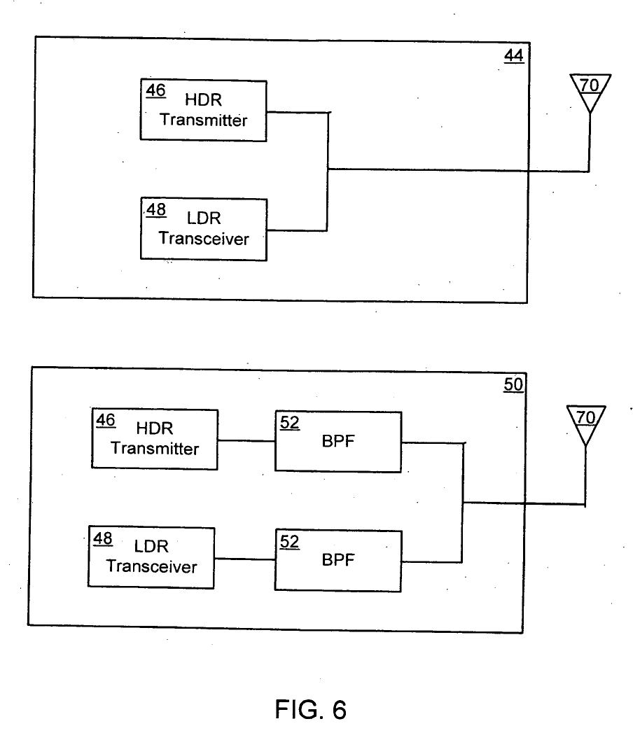

Referring now to FIG. 6, alternative embodiment communication devices 44 and 50 are illustrated. Multi-data rate device 44 comprises an antenna 70, low data rate (LDR) transceiver 48 and a high data rate (HDR) transmitter 46. The multi-data rate device 44 also includes a variety of other components (not shown) such as controller(s), digital signal processor(s), waveform generator(s), static and dynamic memory, data storage device(s), amplifier(s), filter(s), interface(s), modulator(s), demodulator(s), other necessary components, or their equivalents. The controller may include error control, and data compression functions. The multi-data rate device 44 may employ hard-wired circuitry used in place of, or in combination with, software instructions. Thus, embodiments of the multi-data rate device 44 are not limited to any specific combination of hardware or software. The multi-data rate device with band pass filters 50 may be constructed similar to the multi-data rate device 44, with the addition of band pass filters (BPF) 52. The BPFs 52 may be used to crop, or otherwise alter the pulses, or signals emitted by the multi-data rate device with band pass filters 50.

One feature of both the multi-data rate device 44 and the multi-data rate device with band pass filters 50 is that they only contain an HDR transmitter 46, not a HDR transceiver, or a HDR receiver. That is, both communication devices 44 and 50 are structured to transmit data at both high and low data rates, but only receive data at low data rates. In one communication method of the present invention, the low data rate (LDR) transceiver 48 negotiates login, data transfer protocol(s), and other functions with a network or other device. For example, a camcorder, digital camera, audio recorder, or other device may only need an asymmetrical data transfer capability. Once the LDR transceiver 48 has accessed a network or device, such as a computer or stereo system, the HDR transmitter 46 is activated, and downloads, or transmits data stored in the communication devices 44 and 50. Because the camcorder, or other device may only send large amounts of data in one direction, having a bi-directional high data rate capability may be unnecessary. In this communication method, all communication from the network, or other device, back to the communication devices 44 and 50 are conducted by LDR transceiver 48. One feature of this embodiment is that the data transfer rate from the communication devices 44 and 50 to a network, or other device may be increased, but power usage is minimized because only the LDR transceiver 48 is used during initial communication. In addition, by eliminating a HDR receiver, manufacturing and subsequent resale costs are reduced.

As discussed above in connection with FIG. 6, in one method of the present invention, the LDR transceiver 48 initiates all communication. The information included in this low data rate transmission may include network log-on and authentication information, geographic location information, software and firmware revision number, timing of low data rate transmission information, and other information. For example, low data rate transmission information may additionally include a description of the high data rate capability of the communication devices 44 and 50. Other information contained within the low data rate transmission may include a request for a high data rate transmission time period. Within this request the communication devices 44 and 50 may send their requested data rate, type of data to be transmitted, quality of service (QOS) requirements, and size of data to be sent. In a contention based communication protocol environment, such as ALOHA or slotted ALOHA, access to the network, or to other devices, may be requested by transmitting the communication devices 44 and 50 unique Medium Access Control (MAC) address.

Prior to any communication, the communication devices 44, 50, 60 and 60a-e may perform a “clear channel assessment.” This aspect of the invention is discussed above as a “listening time period.” This clear channel assessment (CCA), or listening time period, comprises listening to the radio frequency band for a period of time prior to transmission in the same band, or adjacent bands. The CCA may further comprise mapping or otherwise analyzing any signals present in the frequency band(s) of interest.

By mapping, or otherwise analyzing any signals present in frequency band(s) of interest, the communication devices 44, 50, 60 and 60a-e may determine if transmission may cause interference with other signals. Alternatively, the communication devices 44, 50, 60 and 60a-e may transmit signals or pulses that have been created or shaped to avoid frequencies where signals are present.

In another embodiment of the present invention, data transmitted at low data rates versus high data rates may be transmitted on signals, or pulses, that have different properties. For example, the low and high data rate data may be transmitted with different pulse shapes. In one embodiment the pulse shapes are selected to be mutually orthogonal to each other. In this embodiment pulse shape P₁(t) and P₂(t) are selected to meet the orthogonality condition where the cross-correlation of the two pulse shapes is equal to zero, as shown in the following equation:
∫P₁(t)P₂(t)dt=0

Orthogonality, as described above, reduces the potential interference between pulses and makes it easier for a receiver to discriminate between the two pulses.

In another embodiment the low data rate information may be encoded using differential phase shift keying (DPSK). In ultra-wideband DPSK, two pulses are substantially identical to each other except for their polarity. Information is encoded onto the pulses by assigning a data bit to the transition (i.e., polarity change) from a previous pulse to the current pulse. For example, when a data bit to be sent is a one (1), the current pulse has the same polarity as the previous pulse. When the data bit is a zero (0), the current pulse has the opposite polarity.

One advantage of DPSK over other phase modulation schemes is that a receiver may be less complex. One type of correlating receiver used to detect BPSK signals may use a local template signal that is generated and multiplied by an incoming pulse. The resultant product is then integrated to determine the correlation of the incoming pulse with the template signal. If the incoming pulse is of the same phase as the template, the integral will be positive. If the incoming pulse is of opposite phase, the integrand will be negative. However, this type of correlating receiver may suffer from increased error in an environment where the incoming pulse is difficult to match with a locally generated template signal. Reduced signal-to-noise (SNR) ratios due to increased noise environments may cause the received pulse to be difficult to match with the template signal.

But, in an ultra-wideband DPSK receiver, the current pulse is correlated, with a multiplier followed by integration, with the proceeding pulse. Since the two pulse shapes are identical except for polarity, there are two possibilities. The current pulse is either of the same polarity as the proceeding pulse, wherein the integral output is positive, or the current pulse is of opposite polarity as the proceeding pulse, and the integral output will be negative. Given a first reference pulse of a known data value, the rest of the data stream may be decoded. One advantage of an ultra-wideband DPSK receiver is that both the current and proceeding pulses are subject to the same noise environment and the receiver will have a similar SNR when receiving both pulses. Additionally, an ultra-wideband DPSK receiver may have reduced cost and complexity because there is no need to generate a local template signal.

Another feature of the present invention is that a pseudo-random timing sequence may be employed to transmit LDR frames 10(a) and HDR frames 10(b). This may avoid the generation of spectral lines. That is, if LDR frames 10(a) and HDR frames 10(b) are interleaved at a fixed rate, or period, the difference in communication parameters between frame types, such as power and type of modulation, may cause a significant clustering of energy at specific radio frequencies. These energy clusters, or “spectral lines” may occur at a frequency equal to the inverse of the time between transmission of LDR frames 10(a). Additionally, a spectral line may occur at every integer harmonic of that frequency. For example, if the LDR frames 10(a) are transmitted at a rate of one every microsecond, there may be a spectral line created at 1 megahertz (MHz). Additional lines may be formed at 2 MHz, 3 MHz, 4 MHz, and so on. The creation of spectral lines may cause interference with other signals. To avoid the generation of spectral lines, the communication devices 44, 50, 60 and 60a-e may transmit at a lower power level, which then limits the distance at which they can effectively communicate.

To avoid generating spectral lines, a pseudo-random timing sequence may be employed to transmit LDR frames 10(a) and HDR frames 10(b). By interleaving the LDR frames 10(a) and HDR frames 10(b) in a pseudo-random manner, spectral line formation may be mitigated or reduced. A pseudo-random hopping sequence may be used to determine the location in time of LDR frames 10(a) relative to HRD frames 10(b). In this embodiment, the transmitter and receiver should have prior knowledge of the hopping sequence. This is because even though each communicating device knows the sequence, it appears to be a random sequence to receivers without the hopping sequence. The use of a pseudo-random interleaving sequence generally prevents or dramatically reduces the formation of spectral lines, thereby allowing signals, or pulses to be transmitted at a higher power, enabling longer communication distances.

Yet another feature of the present invention provides a method for load, or bandwidth, balancing between communication devices 44, 50, 60 and 60a-e wishing to transmit data to each other, or to a network access point. As described above, an LDR frame 10(a) may include a contention based time portion, such as ALOHA, slotted ALOHA, or another method, that enables communication devices 44, 50, 60 and 60a-e to request access to a network. As discussed above, the LDR frame 10(a) may include information relating to the type of data to be transmitted. The network access point may then assign a number of HDR frames 10(b) to contending communication devices 44, 50, 60 and 60a-e in an uneven manner, in light of the type, or amount of data to be transmitted. By assigning HRD frames 10(b) in this manner, the network may ensure that users with data requiring reduced latencies (i.e., immediate transmission) may be given time preference over users whose data is less time sensitive.

In this communication method, each device Uᵢ (such as communication devices 44, 50, 60 and 60a-e) requesting access may transmit its requested data rate Rᵢ and the size of the file Sᵢ to be sent. The time Tᵢ for this file transfer may then be calculated as:

$${T}_{i} = \frac{{S}_{i}}{{R}_{i}} .$$

The entire time necessary for Nᵤ devices to transfer their data is then the sum of all times for each device. If “M” HDR frames 10(b) are required for all devices to complete transmission then:

$${\sum }_{i = 1}^{{N}_{u}} {T}_{i} = {MT}_{f} ,$$

where T_{f} is the time duration of the payload section of a HDR frame 10(b). Assuming that each HRD payload is divided into time slots of T_{c} duration then the total time to transfer the data may also be expressed as Tᵢ=MNᵢT_{c} if Nᵢ slots of T_{c} duration are allocated to device Uᵢ within all M frames. It then follows that Nᵢ may be calculated as follows:

$${N}_{i} = \frac{{T}_{i}}{{MT}_{c}}$$

$${N}_{i} = \frac{\frac{{S}_{i}}{{R}_{i}}}{\frac{{T}_{c}}{{T}_{f}} {\sum }_{i = 1}^{{N}_{u}} {T}_{i}}$$

$${N}_{i} = \frac{{N}_{c} {S}_{i}}{{R}_{i} {\sum }_{j = 1}^{{N}_{u}} \frac{{S}_{j}}{{R}_{j}}}$$

The number of time slots within each HDR frame 10(b) for each device may then be dynamically calculated based on the requirements of all requesting communication devices 44, 50, 60 and 60a-e. The above function may require truncation to the next lower integer for each device which may result in a number of extra time slots that may then be allocated. One feature of this method is that all devices requesting access will be allocated an amount of time relative to the task they wish to accomplish. That is, devices with larger amounts of data to send are allocated more time than devices with smaller data transfer requests.

One feature of the present invention is that dissimilar ultra-wideband (UWB) communication devices that use different UWB architectures, protocols, or interfaces may coexist in the same environment if the UWB devices are using a common signaling protocol (CSP), as described herein. For example, a UWB device, such as any one of communication devices 44, 50, 60 and 60a-e, may employ a physical layer (PHY) that communicates over multiple sub-bands of the radio frequency spectrum. Another UWB device, that employs a PHY designed to communicate in a single radio frequency band, may communicate with the multiple sub-band UWB device buy using the CSP of the present invention. On feature of the CSP is that it may first attempt to communicate at the lowest available data rate between the devices. In communicating at the lowest data rate, the CSP may employ one, or a set of protocols, that can negotiate time and radio frequency allocation to ensure some level of interoperability between dissimilar devices.

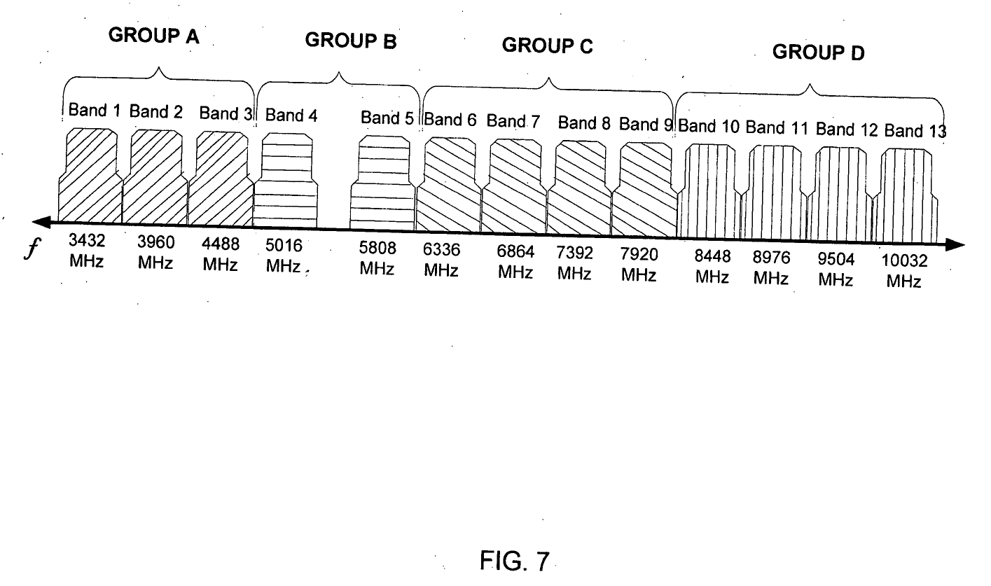

A number of different ultra-wideband PHY's or physical layers are currently under development. In one PHY, the radio frequency band of operation is divided into multiple sub-bands, shown in FIG. 7. Within each sub-band, Orthogonal Frequency Division (OFDM) may be employed. This approach usually requires transmission of data using a number of different frequency bands (such as Bands 1-3) in a time-hopped manner. Currently, the FCC mandates that these frequency bands are at least 500 MHz wide, as shown in FIG. 7. This approach is commonly referred to as Multi-Band OFDM UWB (MBOFDM-UWB).

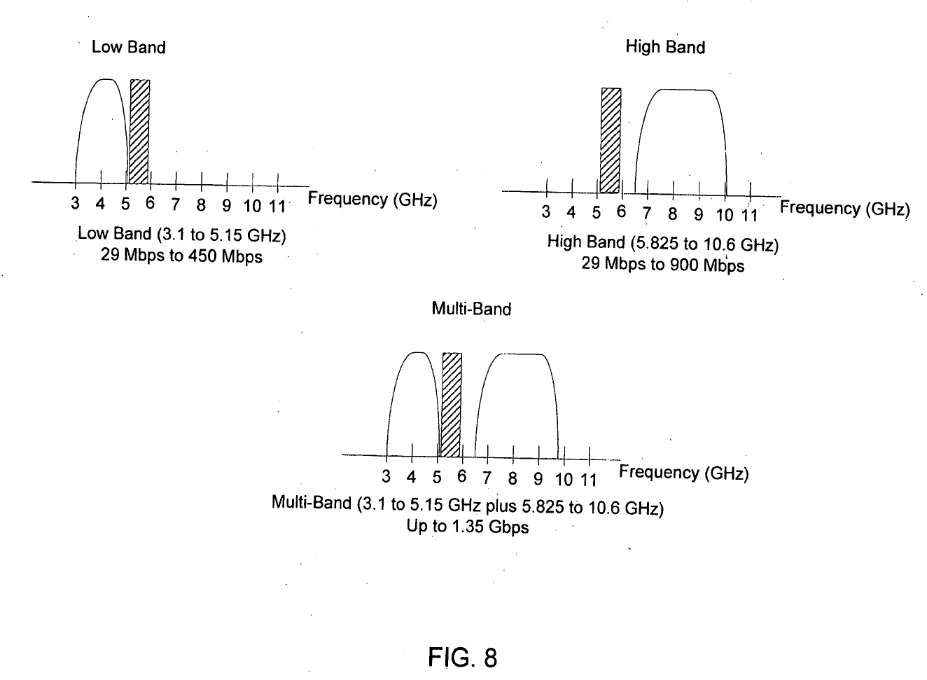

Another PHY design utilizes significantly larger contiguous portions of the radio frequency spectrum. This system, illustrated in FIG. 8, has a number of different communication modes. In a first mode (“Low Band”) the PHY transmits in a single frequency band that is in the lower portion of the available spectrum (around 3-5 GHz). An additional mode (“High Band”) may use a higher frequency range that extents from about 6 to about 10 GHz. In a third mode (“Multi-Band”), the PHY may transmit in both the lower and the higher radio frequency bands. This PHY is commonly referred to as Direct Sequence ultra-wideband (DS-UWB), since the data to be transmitted is first spread using direct sequence spreading techniques.

A number of other applications have been proposed for ultra-wideband communication technology. One such application is low data rate sensor networks. In this application the data rates may be substantially lower than what is required for some of the foreseeable uses of either MBOFDM-UWB or DS-UWB.

Because the above PHYs occupy substantially the same radio frequency bands, there is a real potential for inference. The common signaling protocol (CSP) as herein disclosed may negotiate coexistence between dissimilar PHYs. One feature of the CSP of the present invention is that it will negotiate access to frequency bands of interest among dissimilar devices. That is, if any of communication devices 44, 50, 60 and 60a-e employ different PHYs, the CSP of the present invention will enable communication between them.

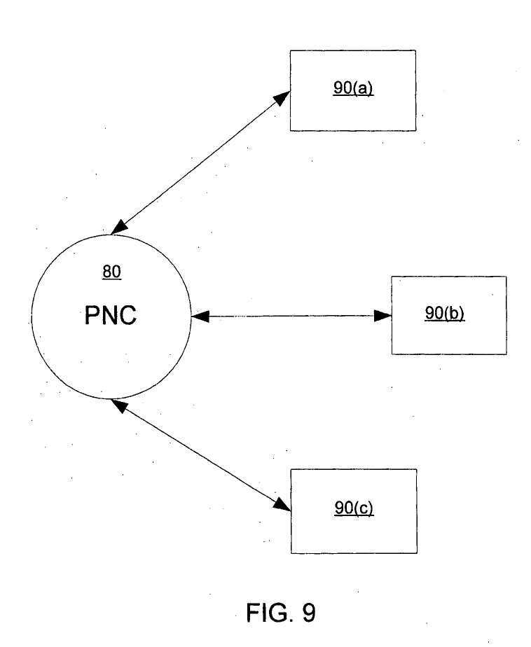

For example, referring to FIG. 9, which illustrates a Piconet Controller (PNC) 80 communicating with UWB devices 90(a) through 90(c). The PNC 80 may be a fixed network access point, or master transceiver, such as 60(d), discussed above in connection with FIG. 4. Alternatively, the PNC 80 may be a mobile, or fixed device that acts as a controller for a piconet. For example, a PNC 80 may be a MBOFDM-UWB access point. A mobile DS-UWB or low data rate UWB device utilizing the CSP would be able to communicate among all types of communication devices that access the PNC 80.

As shown in FIG. 9, in this exemplary network, devices 90(a) through 90(c) may employ different PHYs. Additionally, PNC 80 may have a PHY that is similar to one of the devices 90(a) through 90(c) but dissimilar to other devices that have access to the PNC 80. In one embodiment of the present invention, the CSP may require the dissimilar devices, such as any one of 90a-c to match the chipping rate of the PNC 80. In this embodiment, the chipping rate may be matched by a rate controller or by interpolation to the other chipping rate. In another embodiment, any of devices 90a-c may implement a chip rate that is an integer multiple of the lowest common divisor between their rates. For example, a MBOFDM-UWB device is known that utilizes radio frequency bands of 528 MHz. In this device, a series of three transmissions are sent in each of three consecutive bands. This aggregates to an effective chipping rate of 1.584 Giga-chips per second (Gcps). A DS-UWB device is known that operates at 1.368 Gcps (Low Band) and at 2.736 Gcps (High Band). In one embodiment of the CSP of the present invention, one of the devices would need to include a rate controller to convert to the other chip rate. Alternatively, one device may interpolate the received signal from its chipping rate to the other chipping rate. Interpolation is well known to one skilled in the art.

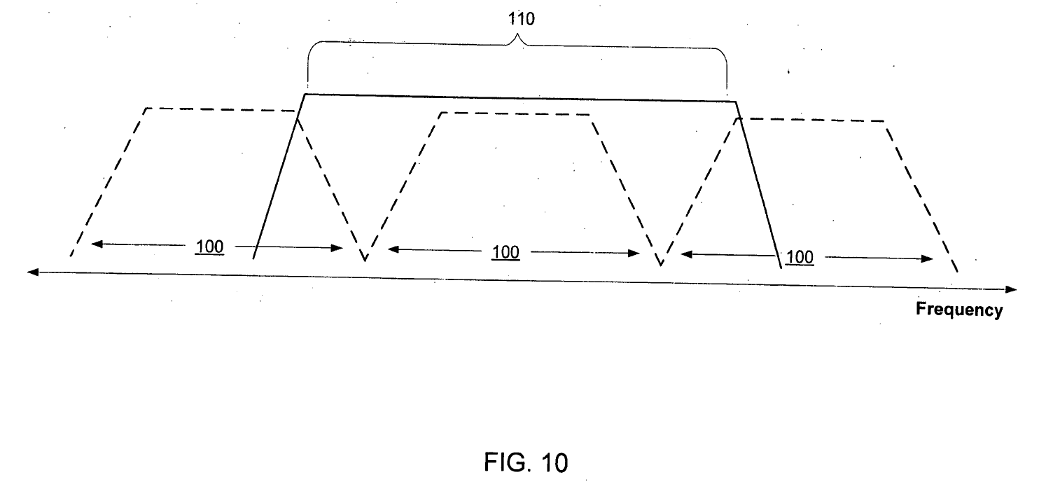

Referring now to FIG. 10, which illustrates different radio frequency band width pulses, or signals. A multiple sub-band system such as a MBOFDM-UWB may have a signal that occupies frequency bands 100. A DS-UWB signal may occupy frequency band 110. When a MBOFDM-UWB receiver attempts to receive a signal from a DS-UWB device it will be able to process portions of the bandwidth that are overlapping, as shown in FIG. 10.

Another embodiment CSP of the present invention requires that all UWB devices, such as 80, 90a-c, 44, 50, 60 and 60a-e, add additional low cost hardware that enables communication at the same chipping rate. In one embodiment, the CSP may transmit pseudo-random codes, such as hierarchical codes, Golay codes, m-sequence codes, Kasami codes, Walsh codes, and other codes during a portion of communication between devices. For example, Golay codes are known to have exceptional auto-correlation and cross-correlation properties, and orthogonal Golay codes may be used to differentiate between different piconets 80. In a preferred embodiment of the present invention, a transceiver, or receiver included within any one of the disclosed UWB devices, such as 80, 90a-c, 44, 50, 60 and 60a-e, may include an efficient Golay correlator that enables the receiver to quickly synchronize with a transmitting device.

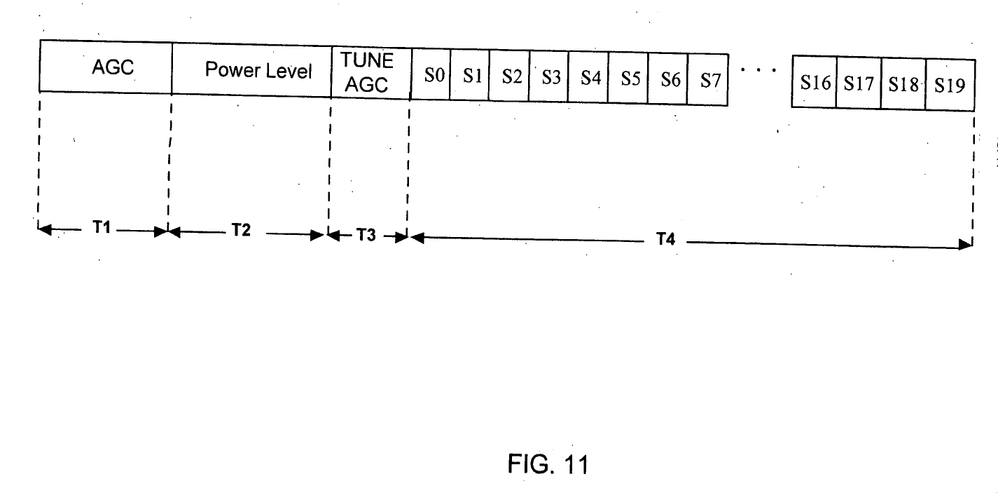

Referring now to FIG. 11, a preamble format that is included within LDR frame 10(a) and/or HDR frame 10(b) is illustrated. The preamble format may include packet synchronization section, a frame synchronization section, and a channel estimation synchronization section. One feature of the present invention is that the frame synchronization section would not only indicate the end of the packet synchronization section, but it would also enable a device to determine the type, or mode of operation of the device transmitting the received data. For example, the device may be a DS-UWB device, or it may be a MBOFDM-UWB device.

Again referring to FIG. 11, the packet synchronization section may include time period T1 that enables the receiver to adjust its automatic gain control (AGC). Time period T2 may be provided for the receiver to measure the power level of distinct receiver chains, or alternatively decide between multiple antennas if the device, such as communication devices 80, 90a-c, 44, 50, 60 and 60a-e, are so equipped. Time period T3 may be provided for the receiver to fine-tune its AGC based on the selections made during time period T2. Time period T4 may be broken into a number of discrete synchronization sequences (S0-S19). It will be appreciated that there may be more or less than the 20 synchronization sequences illustrated. In one embodiment, one or more of the synchronization sequences may be of reverse polarity. Reversing the polarity of one or more synchronization sequences generally improves the probability of correct detection at the end of the synchronization period.

Additional features and functions of the present invention will now be discussed with reference to FIG. 9. As discussed above, FIG. 9 illustrates a Piconet Controller (PNC) 80. Generally, a piconet is a group of two or more devices operating with a common Media Access Control (MAC), which are associated in some manner. For example, the PNC 80 may be a fixed network access point, or a master transceiver. Or, the PNC 80 may be designated as a master transceiver within an ad-hoc network of communicating devices. That is, the PNC 80 may be a mobile, or fixed device that acts as a controller for a piconet. For example, a PNC 80 may be a UWB access point, or it may be a Bluetooth-, or 802.11-enabled device.

In this embodiment of the invention, the PNC 80 is capable of transmitting and receiving using different communication methods: ultra-wideband pulses, and conventional carrier wave, or narrowband signals. Generally, this capability may require the PNC 80 to employ a common MAC while supporting different PHYs. In one embodiment, the PNC 80 can readily co-exist with other existing wireless communication systems that operate in the license-free frequency bands. In yet another embodiment, the PNC 80 can be a “complex” device capable of supporting at least two PHYs, with yet other embodiments of PNC 80 comprising “simple” units that support at least one PHY. In this embodiment, interoperability among PHYs is enabled via the “complex” device, while simplicity, low cost and low power consumption is achieved in the “simple” devices.

For example, as shown in FIG. 9, in this embodiment of the invention, devices 90a-c may be “simple” devices that support one PHY, such as Bluetooth, 802.11, ultra-wideband, or another type of PHY. PNC 80 may be a “complex” device that supports at least two PHYs, allowing it to communicate with the simple devices 90a-c.

It will be appreciated that a PNC 80 may also communicate with other PNC 80s. That is, two or more “complex” devices may establish an ad-hoc network, enabling communication with each other.

An incomplete list of PHYs that may be supported by the present invention include a variety of devices and systems, each with their own distinct PHYs: 802.11, Bluetooth, Global Positioning System (GPS), ultra-wideband (UWB), television (TV) and others, including future PHYs. Each one of these systems may have multiple variations, with each variation requiring a different PHY. For example, currently, there are four different ultra-wideband communication systems: time modulated UWB, direct sequence UWB, multi-band impulse UWB and multi-band orthogonal frequency division multiplexing UWB. The present invention may support all of these, and other PHYs.

The present invention provides a method by which disparate wireless technologies and devices may communicate with each other over a wireless interface. The present invention provides a methodology for allowing different PHYs and technologies to coexist in the same spectrum bands and/or the same physical coverage areas simultaneously. The present invention may function as a communications channel for cooperative management of allocated PHY resources across the time and frequency domains.

One feature of the present invention is that it may provide a method for bandwidth, or communication coordination between different wireless technologies, systems, or devices by functioning as an out-of-band signaling channel. An “out-of-band” channel is any channel, or frequency that is separate from the channel, or frequency used to transmit bits, or data.

For example, two devices, such as a wireless device utilizing a spread spectrum approach to ultra-wideband (UWB) and the other using an Multi-Band Orthogonal Frequency Division Multiplexing (MB-OFDM) approach to UWB, may negotiate usage of the local spectrum based on a time sharing between the two devices. The two devices may negotiate the use of the local spectrum by communicating via an out-of-band channel.

Alternatively, the two devices may be a Bluetooth device and an 802.11 LAN device attempting to operate within the same 2.4 GHz spectrum. These two devices may establish an out-of-band channel to negotiate a shared usage of the local spectrum.

In addition to providing a signaling channel, the present invention could provide a wide spectrum of additional functional capabilities, such as: a beacon timing channel; a beacon ranging channel; a low-bandwidth communications link for low-bandwidth devices; a power conservation function for mobile, or other devices with limited power reserve; a dynamic node-to-node power transmit/receive power control function; a network status/health/control status provider; an over-the-air reprogramming link; an over-the-air rekeying link; a “shut-down” function; and a method for routing updates in a mesh network. Each of these functions will be described below:

Beacon Timing Channel: By functioning as an out-of-band communications channel that all wireless systems are capable of using, the present invention could provide for time precision across wireless networks by functioning as a wireless beacon. In a preferred embodiment, different PHYs would be able to access a common beacon. For example, a Bluetooth-enabled device, and a 802.11-enabled device would access a common beacon channel. This aspect of the present invention would enable the sharing of time information across wireless networks. By sharing time estimations between wireless devices, it becomes possible to generate highly precise time estimates across the network. Higher time accuracy across the network has the potential to provide for increased capacity, especially in Time Division Multiple Access (TDMA) networks by allowing higher time precision TDMA protocols to be utilized.

Beacon Ranging Channel: The present invention may also enable a device, such as PNC 80, to function as a wireless positioning beacon. By allowing a communication device to function as a beacon node, positioning applications would become more easily implemented. A second device, whether another PNC 80, or a device 90a-c, may engage in a two-way ranging process. Two-way ranging enables very accurate ranging, and may provide an indoor E-911 position capability.

The present invention may also provide a low-bandwidth communications link for low-bandwidth devices. Low bandwidth messaging saves bandwidth for users that need additional bandwidth. For example, a low bandwidth security sensor need not utilize a high-bandwidth communications link to report its status information, thereby saving that high-bandwidth capacity for other applications.

The present invention may also provide a power conservation function for mobile devices, or other devices with a limited power reserve. By providing a low-bandwidth communications channel, the present invention enables power conservation in mobile or power-limited devices. For example, devices requiring a low-bandwidth channel would not need to monitor a high-bandwidth channel to acquire or pass low-bandwidth information. In this fashion, a power-limited device is able to improve its power conservation, thereby ensuring longer operation.

The present invention may provide dynamic node-to-node power transmit/receive power control. That is, the present invention may allow wireless links to dynamically control the power transmitted by each end of the link (i.e., each communicating device) to ensure only the minimum transmit power is used to maintain the link. This would be advantageous in applications such as mesh networking to ensure that the local RF environment was kept at the minimum level needed to maintain all the links. Additionally, this functionality of transmit power control allows a wireless device to take advantage of changing regulatory transmit power limits.

The present invention may provide network status/health/control information. Network status, health and control information could be provided over the low-bandwidth, out-of-band channel. For example, updates on node availability in a wireless mesh network could utilize a low-bandwidth, out-of-band channel instead of occupying a high-bandwidth channel.

The present invention may provide an over-the-air reprogramming link. The present invention may pass new communications algorithms, or other programming information to a device to enable new functionality. For example, a device employing a software definable radio (SDR) may receive a program that allows the device to transmit a new waveform. By providing real-time reprogramming, the device's transmission characteristics or capability may be altered, as needed. As regulations change with respect to software definable radios and other cognitive radios, the present invention may be used to update software and firmware to conform to the new regulations. This over-the-air reprogramming function will allow devices to comply with a changing regulatory environment, thereby reducing the cost of redesign and replacement of wireless devices to designers, manufacturers, and consumers alike.

The present invention may provide an over-the-air rekeying function. The present invention may provide an encryption key distribution function for secure networks, thereby enabling over-the-air rekeying of encryption devices. This function may provide security in a communications network.

The present invention may also provide a “shut down” function. Wireless devices may not be accepted in all locations for reasons that vary from security concerns to social reasons. For example, wireless devices are not yet approved for use on airplanes for safety of flight reasons; they are not approved in hospitals for safety of life reasons; and they are typically not desired in movie theaters for social reasons. The present invention may provide a turn-off function to allow businesses, and others to shut down devices when necessary.

The present invention may be used in a mesh network for routing updates. One problem in mobile mesh networks is the updating of routing information to nodes that are already saturated with traffic. By providing a separate, out-of-band signaling channel, the present invention could provide updated routing information to saturated nodes, thereby permitting them to off-load traffic to different nodes. Additionally, traffic bandwidth would not be used to carry common routing information, which would be sent out-of-band, instead of occupying a data, or bit-providing channel.

In addition to providing the above functions, the present invention may also be employed to in other ways: It may be used in cognitive radios; and it may be used to determine interference at a receiver and transmit that information to other devices. Each of these concepts will be discussed below:

The present invention may be used in cognitive radios. The Institute of Electrical and Electronics Engineers (IEEE) has defined the cognitive radio as “a radio frequency transmitter/receiver that is designed to intelligently detect whether a particular segment of the radio spectrum is currently in use, and to jump into (and out of, as necessary) the temporarily unused spectrum very rapidly, without interfering with the transmissions of other authorized users.” The Federal Communications Commission (FCC) has defined Cognitive Radio technologies as those that “make possible more intensive and efficient spectrum use by licensees within their own networks, and by spectrum users sharing spectrum access on a negotiated or an opportunistic basis. These technologies include, among other things, the ability of devices to determine their location, sense spectrum use by neighboring devices, change frequency, adjust output power, and even alter transmission parameters and characteristics.” The present invention will enable communication between dissimilar transmitters, or PHYs, allowing them to share spectrum.

The present invention may also assess and manage interference. The present invention may sample the actual interference seen by a receiver, and provide a communication channel that could be used by transceivers to communicate information on the local interference conditions. This would allow transceivers to dynamically adjust transmit power based upon the target receiver, thereby ensuring the local interference does not jam, or otherwise degrade the transmission. Additionally, the transmit power may be adjusted in light of the interference to avoid exceeding an emission level.

Thus, it is seen a common signaling method is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the instant disclosure, and the present invention is limited only by the instant disclosure. It is noted that various equivalents for the particular embodiments discussed in this description may practice the invention as well.

1. A communication method, the method comprising the steps of:
providing a first communication device having a first physical layer that transmits bits;
providing a second communication device having a second physical layer that transmits bits; and
transmitting the bits between the first communication device and the second communication device.

2. The communication method of claim 1, wherein each of the first and second physical layers establishes a connection to a communication medium for transmitting the bits.

3. The communication method of claim 1, wherein the bits transmitted by the first and second physical layers are transmitted by a carrier wave.

4. The communication method of claim 1, wherein the bits transmitted by the first and second physical layers are transmitted using a plurality of discrete electromagnetic pulses.

5. The communication method of claim 1, wherein the bits transmitted by the first and second physical layers are transmitted using a plurality of ultra-wideband pulses.

6. The communication method of claim 1, wherein the first physical layer transmits bits using a carrier wave, and the second physical layer transmits bits using a plurality of discrete electromagnetic pulses.

7. The communication method of claim 1, wherein each of the first and second physical layers are selected from a group consisting of: an 802.11 physical layer, a Bluetooth physical layer, a global positioning system physical layer, an ultra-wideband physical layer, a television physical layer, a cable television physical layer, a satellite television physical layer, a time modulated ultra-wideband physical layer, a direct sequence ultra-wideband physical layer, a multi-band impulse ultra-wideband physical layer, and a multi-band orthogonal frequency division multiplexing ultra-wideband physical layer.

8. A communication method, the method comprising the steps of:
providing a first communication device having a first physical layer;
providing a second communication device having a second physical layer; and
providing a medium access control that allows transmission of bits between the first communication device and the second communication device.

9. The communication method of claim 8, wherein each of the first and second physical layers are selected from a group consisting of: an 802.11 physical layer, a Bluetooth physical layer, a global positioning system physical layer, an ultra-wideband physical layer, a television physical layer, a cable television physical layer, a satellite television physical layer, a time modulated ultra-wideband physical layer, a direct sequence ultra-wideband physical layer, a multi-band impulse ultra-wideband physical layer, and a multi-band orthogonal frequency division multiplexing ultra-wideband physical layer.

10. The communication method of claim 8, wherein each of the first and second communication devices includes the medium access control.

11. The communication method of claim 8, wherein the medium access control provides a timing beacon that is accessible by both the first and second communication devices.

12. The communication method of claim 8, wherein the medium access control provides a positioning beacon so that a geographic location of each of the first and second communication devices is known.

13. The communication method of claim 8, wherein the medium access control provides both a high data rate and a low data rate function to each of the first and second communication devices.

14. The communication method of claim 8, wherein the medium access control provides a power conservation function to each of the first and second communication devices.

15. The communication method of claim 8, wherein the medium access control provides a signal transmission power function to each of the first and second communication devices.

16. The communication method of claim 15, wherein the signal transmission power function adjusts a transmission power of a signal emitted by either the first or second communication devices.

17. The communication method of claim 8, wherein the medium access control provides a node availability function to each of the first and second communication devices.

18. The communication method of claim 17, wherein the node availability function provides information on a node in a mesh network.

19. The communication method of claim 8, wherein the medium access control provides a re-programming function to each of the first and second communication devices.

20. The communication method of claim 19, wherein the re-programming function provides a computer software program to each of the first and second communication devices.

21. The communication method of claim 8, wherein the medium access control provides a security encryption key to each of the first and second communication devices.

22. The communication method of claim 8, wherein the medium access control provides a shut-down function to each of the first and second communication devices that turns off the first and second communication devices.

23. The communication method of claim 8, wherein the medium access control determines an electromagnetic interference in a radio frequency band.

24. The communication method of claim 8, wherein the medium access control determines an electromagnetic interference in a radio frequency band and adjusts a signal transmission power of each of the first and second communication devices.

25. A communication network, comprising:
a medium access control structured to communicate with at least two different physical layers.

26. The communication network of claim 25, wherein the at least two different physical layers are selected from a group consisting of: an 802.11 physical layer, a Bluetooth physical layer, a global positioning system physical layer, an ultra-wideband physical layer, a television physical layer, a cable television physical layer, a satellite television physical layer, a time modulated ultra-wideband physical layer, a direct sequence ultra-wideband physical layer, a multi-band impulse ultra-wideband physical layer, and a multi-band orthogonal frequency division multiplexing ultra-wideband physical layer.

27. The communication network of claim 25, wherein the medium access control provides a timing beacon that is accessible by both of the at least two different physical layers.

28. The communication network of claim 25, wherein the medium access control provides a positioning beacon so that a geographic location of each of the at least two different physical layers is known.

29. The communication network of claim 25, wherein the medium access control provides both a high data rate and a low data rate function to each of the at least two different physical layers.

30. The communication network of claim 25, wherein the medium access control provides a power conservation function to each of the at least two different physical layers.

31. The communication network of claim 25, wherein the medium access control provides a signal transmission power function to each of the at least two different physical layers.

32. The communication network of claim 31, wherein the signal transmission power function adjusts a transmission power of a signal emitted by either of the at least two different physical layers.

33. The communication network of claim 25, wherein the medium access control provides a node availability function to each of the at least two different physical layers.

34. The communication network of claim 33, wherein the node availability function provides information on a node in a mesh network.

35. The communication network of claim 25, wherein the medium access control provides a re-programming function to at least two communication devices that include the at least two different physical layers.

36. The communication network of claim 35, wherein the re-programming function provides a computer software program to each of the at least two communication devices.

37. The communication network of claim 25, wherein the medium access control provides a security encryption key to each of at least two communication devices that include the at least two different physical layers.

38. The communication network of claim 25, wherein the medium access control provides a shut-down function to each of at least two communication devices that include the at least two different physical layers.

39. The communication network of claim 25, wherein the medium access control determines an electromagnetic interference in a radio frequency band.

40. The communication network of claim 25, wherein the medium access control determines an electromagnetic interference in a radio frequency and adjusts a signal transmission power of at least two communication devices that include the at least two different physical layers.

41. A communication method, the method comprising the steps of:
providing a radio frequency;
providing a first communication device having a first physical layer;
providing a second communication device having a second physical layer; and
transmitting bits between the first communication device and the second communication device using the radio frequency.

42. The communication method of claim 41, further comprising the step of:
providing a second radio frequency, wherein either the first or second radio frequency includes signaling information.

43. The communication method of claim 42, wherein the signaling information comprises information selected from a group consisting of: timing information, geographic location information, signal transmission power information, security encryption key information, shut-down information, and electromagnetic interference information.

44. The communication method of claim 41, wherein each of the first and second physical layers are selected from a group consisting of: an 802.11 physical layer, a Bluetooth physical layer, a global positioning system physical layer, an ultra-wideband physical layer, a television physical layer, a cable television physical layer, a satellite television physical layer, a time modulated ultra-wideband physical layer, a direct sequence ultra-wideband physical layer, a multi-band impulse ultra-wideband physical layer, and a multi-band orthogonal frequency division multiplexing ultra-wideband physical layer.
